(19) United States
(12) Patent Application Publication
(10) Pub. No.: US 2009/0094456 A1
(43) Pub. Date: Apr. 9, 2009

(54) METHOD FOR PROTECTION AGAINST ADULTERATION OF WEB PAGES

(75) Inventors: Wilson Vicente Ruggiero, Sao Paulo - SP (BR); Leon Achjian, JR., Sao Paulo - SP (BR); Cesar Alison Monteiro Paixao, Sao Paulo - SP (BR)

Correspondence Address: DARBY & DARBY P.C., P.O. BOX 770, Church Street Station, New York, NY, 10008-0770, US

(73) Assignee: Scopus Tecnologia Ltda., Sao Paulo - SP (BR)

(21) Appl. No.: 12/235,741

(22) Filed: Sep. 23, 2008

(30) Foreign Application Priority Data
Oct. 4, 2007 (BR) PI0705090-9

(51) Int. Cl. H04L 9/00

(52) U.S. Cl. 713/168

(57) ABSTRACT

The method verifies the integrity and authenticity of a page received by the browser client (10) provided in a terminal station (E) of a user client. The method uses two program modules:
a signature program module (22): an application executed by the Web server (21) provided in an institution (I) and which intercepts the pages to be sent to the user client and, in case the page is configured as a page to be signed, said module performs the signature with an identifier code and includes, at the end thereof, a tag, whose content is the signature.
a verification program module (12): an application executed in the environment of the user client which monitors the pages accessed by the browser client (10). Upon finding a page to be validated, it verifies the presence of the signature tag and validates whether the signature is correct, that is, whether it has really been executed by the correct server and whether the identifier code (HTML) has not been modified.

### FIELD OF THE INVENTION

The present invention refers to a method for providing, to a user client of an institution of protected access, the integrity and authenticity of the pages received from this institution through the WEB browser. The method proposed herein is particularly adequate to guarantee the authenticity, integrity and the non-refusal of documents.

### PRIOR ART

The proliferation of attacks to the user client's DNS server, to the user client's proxy server, to the local configuration files for resolution of the user client's names (for example host files), and of any attack using a false page which has the correct URL of the attacked website, has created the necessity of new methods for guaranteeing a correct and secure identification (authentication) of the Web pages.

Due to the non-existence of page verification within the Web scenery, it is common the occurrence of attacks using false pages.

### DISCLOSURE OF THE INVENTION

As a function of this problem, it is an object of the present invention to provide a method to supply the user of an institution of protected access, such as a banking institution, with a procedure for verifying the digital signature of Web pages, which consists in adding, at the end of a code, for example a HTML code, a tag whose content is the digital signature of the page.

Before being sent to the user client by the institution server, the page is intercepted by a signer module which performs the signature of the code and includes, at the end of the latter, a tag with the calculated digital signature.

In the user client there is provided a verification program module which monitors the pages being accessed by the browser. Upon finding a page to be validated, the presence of the tag is verified and the extracted signature is validated.

The digital signatures have the purpose of ensuring the identification of the document origin and validating the authenticity and the integrity of its content. Said digital signatures use generally public key code algorithms, based on the concept according to which each entity has a pair of keys (public and private) mathematically linked together.

The private-key is used to sign the message and must be securely kept, and the key code is generally used to verify the signature authenticity and may be freely revealed.

In the user client, the application that verifies the signature of the page is made available using a means, for example the program Active X, provided by Microsoft, which permits executing the activities of several natures in dynamic pages.

For the objects of the invention, the present method is directed to institutions which need that the page being displayed to the user client has not been adulterated by applications of any nature, as it occurs with the banking institutions.

For performing the present method, the institution whose access, via Internet, is to be protected, is provided with a Website and a Web server, while each user client, to access the institution, is provided with a terminal station provided with a browser client and a screen.

According to the invention, the method for protection against adulteration of Web pages requested by the user client to the institution comprises the steps of:

providing, at the institution, a signature program module linked to a private-key;

making available, for execution in the terminal station, a verification program module linked to a key code compatible with the private-key;

verifying, by means of the operational interaction of the verification program module with the digital signature program module, whether a Web page requested to the institution from the terminal station and displayed in its screen, is a Web page previously configured as authentic at the institution and at the terminal station;

once the requested Web page is recognized as authentic by the signature program module, providing, through the latter, the digital signature of said page with an identifier code including a tag calculated at each page request operation; and

sending the Web page, with the digital signature, to the verification program module of the terminal station, to repass the authenticated page to the browser client and to cancel the browsing in case the page has not been authenticated.

The invention, summarizedly defined above, solves the main problems related to page adulteration.

### BRIEF DESCRIPTION OF THE DRAWING

The invention will be described below, with reference to the enclosed drawing, given by way of example of an embodiment of the invention and in which:

FIG. 1 represents a schematic diagram of the elements that compose the invention, illustrating the interaction between said elements.

### DESCRIPTION OF THE INVENTION

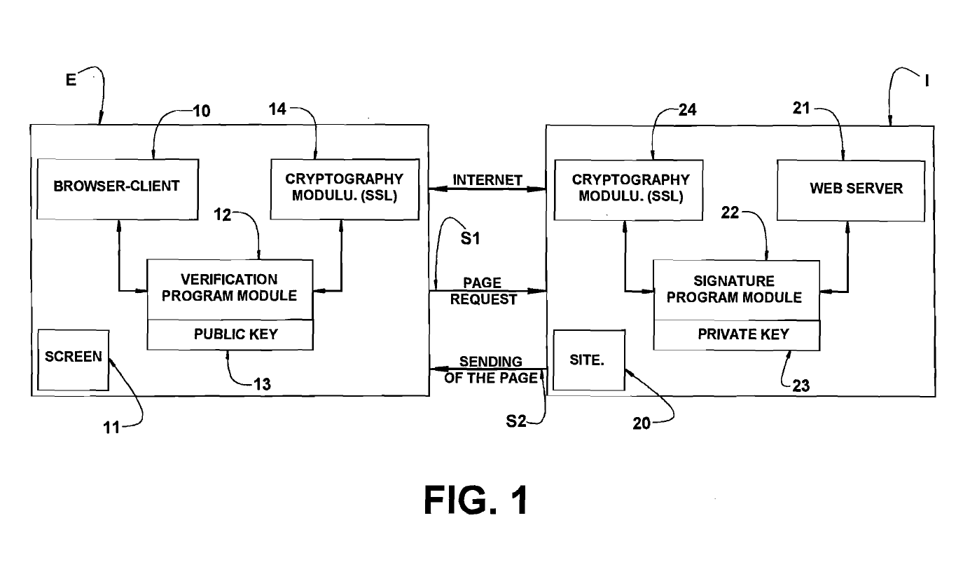

As it can be noted in the diagram of FIG. 1, the present method is particularly adequate for the operations of protected electronic access to an institution I, for example, a banking institution provided with a Website 20 to be electronically accessed by user clients, a Web server 21 of a known and adequate construction, and a signature program module 22 operatively associated with a private-key 23, which is securely maintained to be used in the digital signature of a Web page, aiming at preventing third parties from adulterating Web pages requested to the institution I, more specifically to the Website 20 thereof. The object of the proposed solution is to give guaranties to the user that he is accessing authentic pages of the institution I. The signature program module 22 is operatively integrated to a cryptography module 24.

The present method requires that the electronic access of the user client to the institution I be made through a terminal station E, which can present different constructions, such as a desktop or portable microcomputer or also any other processor device provided with a browser client 10, a screen 11 and a verification program module 12, operatively associated with a generally public-key code 13, which is mathematically linked to the private-key 23. Both the public-key 13 and the private-key 23 can be defined by secrets Kp and Kr, respectively.

The browser client 10 is operatively integrated to a cryptography module 14, in a known manner.

The verification program module 12 is installed and made available at the terminal station E with the permission of the user client, for example, by downloading the adequate program, such as the Microsoft's Active X from the Website 20 of the institution I.

According to the invention, the Web page validation method requested to the institution I, from the terminal station E, can be executed in the form described below. The user client electronically requests, via Internet and by means of a known operation S1, a Web page to the Web server 21 of the institution I. The requested Web page is previously configured, both at the terminal station E of the user client and at the Web server 21, as a signed page, that is, an authentic page.

The Web server 21, the signature program module 22 and the verification program module 12 perform, together, the processing of the characteristics of the requested Web page. Once the WEB page is recognized as an authentic page, the institution I returns, to the terminal station E, in an operation indicated in S2, an identifier code in which a signature is inserted in the form of a tag calculated for each access operation.

The cryptography module 24, in the Web server 21 of the institution I, encrypts the data relative to the requested Web page and the authentication signature thereof, using the SSL protocol, for example. The recognized Web page is sent, by the operation indicated in S2 in FIG. 1, via Internet, to the terminal station E of the user client, in which the respective cryptography module 14 decrypts the data using the same protocol, for example, the SSL. The verification program module 12 opens the identifier code, which can be HTML, extracting the signature and verifying with the one previously defined.

If the signature is correct, the identifier code (HTML) is repassed to the browser client 10. Otherwise, the browsing is interrupted.

The implementation of the signature program module 22 must be performed using the tools available by the Web server 21 in use. The table below illustrates a list of Web servers and the respective technologies used, which can be applied to implement the present method:

| Web Server | Technology Used |
|---|---|
| Microsoft Internet | ISAPI |
| Information Services | |
| Apache HTTP Server | Apache Filter |

The signature program module 22 must perform the following tasks:
1. Intercepting all the pages returned by the Web server 21.
2. Verifying whether the returned page is or not a page to be signed (based on a pre-registered URL list).
3. Performing the signature of the identifier code (HTML).
4. Including, at the end of the code (HTML), a tag, whose content is the signature calculated in the step above.
5. Continuing the process of sending the page, now with the modified code (HTML).

The verification program module 12 executes the following tasks:
1. Monitoring all the pages being accessed by the browser client 10.
2. Verifying whether the returned page is or not a page which must be signed (based on a pre-registered URL list).
3. Verifying the presence of the signature tag at the end of the code (HTML). In case the tag does not exist, the browsing is canceled.
4. Extracting the code signature (HTML).
5. Verifying whether the extracted signature is correct (whether it has really been executed by the correct server and whether the code (HTML) has not been modified). In case the signature is not correct, the browsing is canceled.
6. Repassing the code (HTML) to the browser, continuing the browsing normally.

The signature and the verification of the data will be performed using, for example, the BLS algorithm. This algorithm is indicated by its velocity in the signature process and by the small size of the generated signature. Since the Web server is the critical point in the performance of this system, the priority was to optimize the signature process. Besides, since the signature verification process is distributed (each user client verifies his page separately), the velocity of this processing is not so critical. However, a variation in implementing said process could be made with the RSA, DAS and ECDSA algorithms.

For aggregating security to the system, the signature program module 22 can have the private-key 23 obfuscated within its code and it will only obtain the open key in volatile memory. The verification program module 12 must follow the same process, considering the corresponding key code 13, normally a public-key.

1. A method for protection against adulteration of Web pages by authenticating the pages that have been requested, via Internet, to an institution of protected access provided with a site and a Web server, from a terminal situation of a user client provided with a browser client and a screen, said method comprising the steps of:
providing, at the institution, a signature program module linked to a private-key;
making available, for execution in the terminal stations, a verification program module linked to a key code compatible with the private-key;
verifying, by means of the operational interaction of the verification program module with the digital signature program module, whether a Web page requested to the institution from the terminal station and displayed in the screen thereof, is a Web page previously configured as authentic at the institution and at the terminal station;
recognizing the requested web page as authentic by the signature program module, and providing, through the latter, the digital signature of said page with an identifier code including a tag calculated at each page request operation; and
sending the Web page, with the digital signature, to the verification program module of the terminal station, to repass the authenticated page to the browser client and to cancel the browsing in case the page has not been authenticated.

2. The method, as set forth in claim 1, wherein the verification program module is obtained from the site of the institution.

3. The method, as set forth in claims 1 wherein the key code linked to the verification program module is a public-key.

4. The method, as set forth in claim 1 wherein the browser client and the Web server are operatively integrated to the respective cryptography modules.

5. The method, as set forth in claim 1, wherein the cryptography modules use the SSL protocol.

6. The method, as set forth in claim 1, wherein the identifier code is the HTML code.
